(19) United States
(12) Patent Application Publication
(10) Pub. No.: US 2019/0000136 A1
(43) Pub. Date: Jan. 3, 2019

(54) SMOKE GAS FILTER DEVICE AND TOBACCO PRODUCT

(71) Applicant: Linde ZHANG, Shenzhen (CN)

(72) Inventor: Linde ZHANG, Shenzhen (CN)

(21) Appl. No.: 16/067,595

(22) PCT Filed: Jan. 17, 2017
(86) PCT No.: PCT/CN2017/071331

§ 371 Date: Jun. 30, 2018

(30) Foreign Application Priority Data
Jan. 18, 2016 (CN) 201610031451.0

(51) Int. Cl. A24D 3/16; A24F 13/06; B01D 53/04

(52) U.S. Cl. CPC A24D 3/163; A24F 13/06; B01D 2259/4541; B01D 2253/102; B01D 2257/7027; B01D 53/0407

(57) ABSTRACT

A smoke gas filter device and a tobacco product. The smoke gas filter device is formed with a smoke gas filter channel (L). The smoke gas filter channel (L) is provided with a graphene material segment (1). The graphene material segment (1) is a graphene material powder segment, a graphene material aerogel segment or a graphene material film segment. A graphene material is graphene and/or functionalized graphene. The smoke gas filter device has a large adsorption capacity, and the adsorption is firm, which helps to reduce amount of the toxic substances entering the human body in the smoke gas, reducing the harm to the human body while smoking.

### CROSS REFERENCE TO RELATED APPLICATIONS

This application is the national phase entry of International Application No. PCT/CN2017/071331, filed on Jan. 17, 2017, which is based upon and claims priority to Chinese Patent Application No. 201610031451.0, filed on Jan. 18, 2016, the entire contents of which are incorporated herein by reference.

### TECHNICAL FIELD

The present invention relates to the field of tobacco, particularly to a smoke gas filter device and a tobacco product.

### BACKGROUND

Smoking can bring people spiritual enjoyment, but a series of substances harmful to the human body are formed during the combustion of tobacco, therefore smoking is harmful to health. Similarly, same problems exist in tobacco products such as cigars. The harmful compounds that tobacco produces during combustion include nicotine (L-Nicotine), nitrosamines, carbon monoxide, polycyclic aromatic hydrocarbons (PAHs), tar, cyanide, formaldehyde, acrolein, and heavy metals, etc. In order to reduce the amount of harmful substances inhaled by smokers, current cigarettes are usually provided with a filter tip. The filter tip may be specifically cellulose acetate etc. However, the existing filter tip has poor filtering effect and can merely block part of the tar. Most harmful substances in the smoke gas, especially carcinogens, can still enter the human body and damage the human body.

### SUMMARY

In order to solve the above technical problems, the present invention provides a smoke gas filter device and a tobacco product.

In one aspect, the present invention provides a smoke gas filter device formed with a smoke gas filter channel. A graphene material segment is provided within the smoke gas filter channel. The graphene material segment is a graphene material powder segment, a graphene material aerogel segment or a graphene material film segment. The graphene material is graphene and/or functionalized graphene. The functionalized graphene is one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylated graphene, dodecylated graphene, octadecylated graphene, fluorinated graphene, brominated graphene, chlorinated graphene, and iodinated graphene.

Further, the graphene material segment includes: graphene, aminated graphene, carboxylated graphene, sulfonated graphene, and thiolated graphene.

Further, the smoke gas filtering device includes a shell, the shell forms the smoke gas filter channel. The smoke gas filter device further includes: a first gas-permeable support segment and a second gas-permeable support segment arranged in the smoke gas filter channel. The graphene material segment is arranged between the first gas-permeable support segment and the second gas-permeable support segment.

Further, the first gas-permeable support segment and/or the second gas-permeable support segment is a cellulose acetate segment, a polypropylene segment, an alumina segment, or a cotton segment.

Further, the shell is a hard shell. The shell successively includes a filter segment and a cigarette accommodating segment along the axial direction thereof. The filter segment forms the smoke gas filter channel. The cigarette accommodating segment communicates with the first end of the smoke gas filter channel. The cigarette accommodating segment is formed with a cigarette accommodating chamber for accommodating cigarettes.

Further, a cigarette holder segment is also included. The cigarette holder segment communicates with the second end of the smoke gas filter channel of the filter segment. Besides, in the cigarette holder segment, from the outer surface of one end close to the filter segment to the outer surface of one end far from the filter segment, arc surfaces with gradually decreasing cross sections are formed.

Further, the cigarette accommodating segment is detachably connected to the filter segment, and/or the cigarette holder segment is detachably connected to the filter segment.

Further, the weight of the graphene material segment is 0.5 mg to 50 mg.

The present invention further provides a tobacco product including: a tobacco segment, and the smoke gas filter device according to any of the above-mentioned implementations 1 to 5 and the 8th implementation. The smoke gas filter device is connected to one end of the tobacco segment.

The present invention further provides an application of a graphene material in adsorbing polycyclic aromatic hydrocarbons. The graphene material is graphene and/or functionalized graphene. The functionalized graphene is one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylated graphene, dodecylated graphene, octadecylated graphene, fluorinated graphene, brominated graphene, chlorinated graphene, and iodinated graphene.

The present invention provides a smoke gas filter device, the smoke gas filter device uses a graphene material as a filter material. On one hand, the graphene material is a two-dimensional material with a large specific surface area. In addition, the present invention directly uses the graphene material as a filter segment, rather than loading the graphene material on other materials, thereby making two surfaces on the two-dimensional plane of the graphene material exert an adsorption effect, and the adsorption capacity of toxic substances in the smoke gas is high. On the other hand, graphene can be considered as a carbon material composed of sp2 hybridized carbon atoms, each carbon atom provides a Pz orbital and electrons to participate in the formation of the large π bond on the graphene surface. Therefore, the entire surface of graphene can be considered to be covered by large π bonds. Meanwhile the surface of PAHs also has a large π bond system, thus a bonds of the two systems are overlapped while PAHs and graphene are in contact, thereby forming a π-π interaction between graphene and PAHs. Because π-π interaction is strong, the adsorption capacity of PAHs by graphene is large and the adsorption is firm. On the other hand, the functionalized graphene in the graphene material can have a firmer adsorption effect on specific species, this is because functional groups on the functionalized graphene have directivity and can form chemical bonds (ionic bonds, covalent bonds or secondary bonds) with chemical species having certain specific structures, thus the chemical species having specific structure forms a chemical adsorption. Compared with the traditional physical adsorption, the chemical adsorption has higher adsorption strength and is also more targeted. Therefore, even if smoke gas continuously passes through the graphene material segment, due to the selectivity and strong adsorption capacity of chemical bonds (ionic bonds, covalent bonds, or secondary bonds), the target chemical species are not easily desorbed. Therefore, the smoke gas filter device provided by the present invention has a large adsorption capacity and the adsorption is firm, which helps to reduce the toxic substances in the smoke gas to enter the human body and reduce the harms of smoking to the human body. In addition, since the graphene material has the above-mentioned excellent adsorption performance, only a small amount of graphene material are required to be used, moreover, the graphene is light, thus helping to reduce the weight and the size of the smoke gas filter device, making consumers feel comfortable during the use. Experiments have proved that the smoke gas filter device provided by the present invention can make the removal rate of PAHs with significant carcinogenic activity reach 85% to 100%.

### BRIEF DESCRIPTION OF THE DRAWINGS

The drawings forming a part of the present invention are used to provide a further understanding of the present invention. The exemplary embodiments of the present invention and the description thereof are used to explain the present invention and do not constitute inappropriate limitations to the present invention. In the drawings:

FIG. 1 is a structural schematic view of a smoke gas filter device provided by the first embodiment of the present invention.

FIG. 2 is a structural schematic view of a smoke gas filter device provided by the second embodiment of the present invention.

FIG. 3 is a structural schematic view of a smoke gas filter device provided by another preferred embodiment of the present invention.

FIG. 4 is a structural schematic view of a tobacco product provided by the third embodiment of the present invention.

FIG. 5 is a structural schematic view of an inspection device for adsorption testing of the present invention.

### DESCRIPTION OF THE REFERENCE NUMERALS

| | |
|---|---|
| 1 graphene material segment | 2 shell |
| 31 first gas-permeable | 32 second gas-permeable |
| support segment | support segment |
| 4 tobacco segment | S1 cigarette accommodating segment |
| S2 filter segment | L smoke gas filter channel |

### DETAILED DESCRIPTION

It should be noted that the embodiments in the present invention and the features in the embodiments can be combined with each other without conflict. The present invention will be described in detail below with reference to the drawings and in conjunction with the embodiments.

In the combustion of tobacco, a series of complicated substances are often formed, including nicotine (L-Nicotine), nitrosamines, carbon monoxide, polycyclic aromatic hydrocarbons (PAHs), tar, cyanide, formaldehyde, acrolein, and various heavy metals, etc. Among these, nitrosamines, PAHs, and acrolein are highly carcinogenic substances. In particular, actually, the PAHs among them is a general designation of a series of polycyclic aromatic hydrocarbons, including benzo[a]pyrene, benzo[e]pyrene, benzo[b]fluoranthene, benzo[k]fluoranthene, benzo[j]fluoranthene, dibenzo[a,h]anthracene, dibenzo[a,h]acridine, dibenzo[a,j]acridine, 7-H-dibenzo[c,g]carbazole, chrysene, indeno pyrene, etc., most of which have significant carcinogenic activity. Benzo[a]pyrene is even a representative of carcinogenicity.

The inventor found that the main reason for the poor filterability of the existing filter cigarette holders is as follows. In the smoke gas, the PAHs are often dissolved in the tar and carried out by the tar. However, the existing filter cigarette holder merely has the ability to adsorb partial tars. After tars are adsorbed, the PAHs entrapped therein can only be temporarily adsorbed in the filter cigarette holder. When the smoke gas continuously passes through the filter cigarette holder, due to the fact that PAHs have relatively small molecular weights, the PAHs will be carried out of the filter cigarette holder to enter the human body under the action of the smoke gas, causing harm to the human body. In another aspect, the PAHs can also be transferred to enter the human body from the smoke gas by the particle surface adsorption, or directly in the gaseous form with certain concentration. Besides, as for other toxic compounds, either the existing filter cigarette holder has weak adsorption capacity on them, or the toxic compounds are desorbed and enter the human body again with the smoke gas after being adsorbed.

Accordingly, the present invention first provides an application of graphene materials in adsorption of polycyclic aromatic hydrocarbons (PAHs). The above-mentioned graphene materials are graphene and/or functionalized graphene. The functionalized graphene is one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylated graphene, dodecylated graphene, octadecylated graphene, fluorinated graphene, brominated graphene, chlorinated graphene, and iodinated graphene.

First, as a two-dimensional material, the graphene material has a very high specific surface area, thus having an excellent adsorption effect. As for graphene, graphene can be considered as a carbon material composed of sp² hybridized carbon atoms, where each carbon atom provides a Pz orbital and electrons to participate in the formation of the large π bond on the graphene surface. Therefore, the entire surface of graphene can be considered to be covered by large π bonds. Meanwhile the surface of PAHs also has a large π bond system, thus π bonds of the two systems are overlapped while PAHs and graphene are in contact, thereby forming a π-π interaction between graphene and PAHs. Because π-π interaction is strong, the adsorption capacity of PAHs by graphene is large and the adsorption is firm. As for the functionalized graphene, it can have a firmer adsorption effect on specific chemical species, this is because functional groups on the functionalized graphene have directivity and can form chemical bonds (ionic bonds, covalent bonds or secondary bonds) with chemical species having certain specific structures, thus the chemical species having specific structures forms a chemical adsorption. Compared with the traditional physical adsorption, the chemical adsorption has higher adsorption strength and is also more targeted. Therefore, even if smoke gas continuously passes through the graphene material segment, due to the selectivity and strong adsorption capacity of chemical bonds (ionic bonds, covalent bonds, or secondary bonds), the target chemical species is not easily desorbed. Therefore, the above-mentioned graphene material has the features of large adsorption capacity for PAHs, firm adsorption and being not easily desorbed.

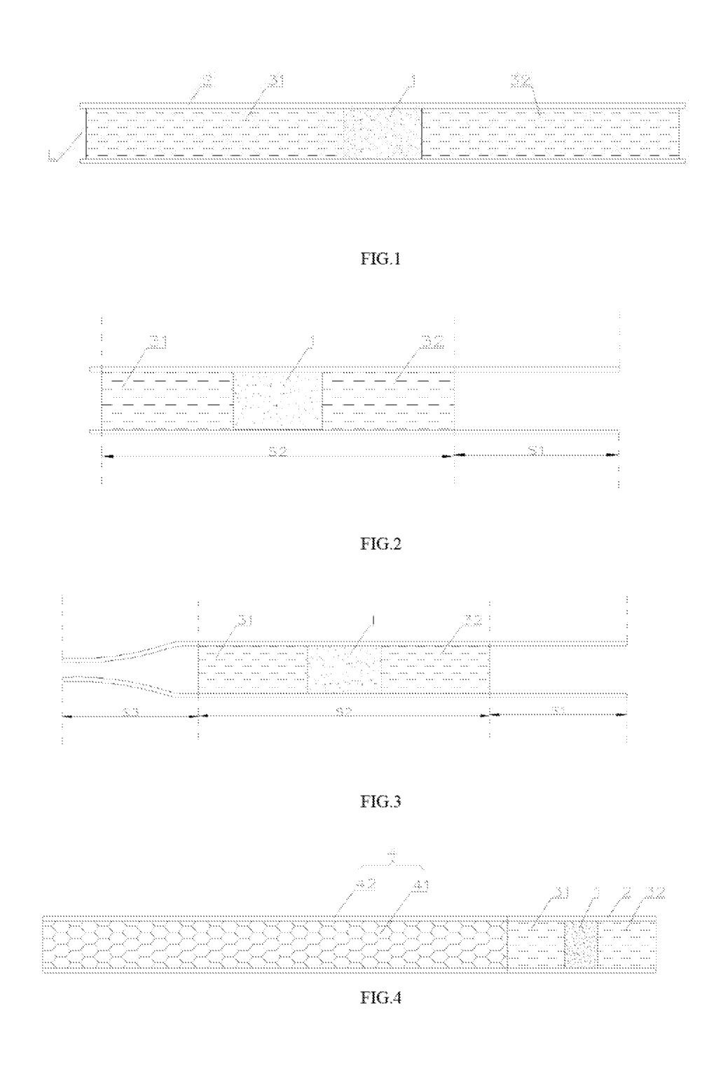

The present invention also provides a new type of smoke gas filter device. The smoke gas filter device uses graphene material as a filter material. Specifically, referring to FIG. 1, which shows the structure of a smoke gas filter device provided by the first embodiment of the present invention. The smoke gas filter device is formed with a smoke gas filter channel L. A graphene material segment 1 is provided inside the smoke gas filter channel L. The graphene material segment 1 is a graphene material powder segment, a graphene material aerogel segment, or a graphene material film segment. The graphene material can be graphene and/or functionalized graphene. The above-mentioned graphene may be one or more of single-layer graphene, oligo-layer graphene or a multilayer graphene (the oligo-layer graphene has more than one layer and less than three layers, and the multilayer graphene has more than three layers and less than ten layers).

The functionalized graphene may be one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylate graphene, dodecylated graphene, octadecylated graphene, fluorinated graphene, brominated graphene, chlorinated graphene, and iodinated graphene.

Graphene material is used as a filter material in this embodiment. On one hand, the graphene material is a two-dimensional material with a large specific surface area. In addition, the present invention directly uses the graphene material as a filter segment, rather than load the graphene material on other materials, thereby making two surfaces on the two-dimensional plane of the graphene material can exert an adsorption effect, and the adsorption capacity for toxic substances in the smoke gas is high. On the other hand, graphene can be considered as a carbon material composed of sp2 hybridized carbon atoms, each carbon atom provides a Pz orbital and electrons to participate in the formation of the large a bond on the graphene surface. Therefore, the entire surface of the graphene can be considered to be covered by large π bonds. Meanwhile, the surface of PAHs also has a large π bond system, thus π bonds of the two systems are overlapped while PAHs and graphene are in contact, thereby forming a π-π interaction between graphene and PAHs. Because π-π interaction is strong, the adsorption capacity of PAHs by graphene is large and the adsorption is firm. On the other hand, the functionalized graphene in the graphene material can have a firmer adsorption effect on specific chemical species, this is because functional groups on the functionalized graphene have directivity and can form chemical bonds (ionic bonds, covalent bonds or secondary bonds) with chemical species having certain specific structures, thus the chemical species having specific structures forms a chemical adsorption. Compared with the traditional physical adsorption, the chemical adsorption has higher adsorption strength and is also more targeted. Therefore, even if smoke gas continuously passes through the graphene material segment, due to the selectivity and strong adsorption capacity of chemical bonds (ionic bonds, covalent bonds, or secondary bonds), the target chemical species is not easily desorbed. Therefore, the smoke filter device provided by the embodiment of the present invention has a large adsorption capacity, pertinence, and a firm adsorption, which helps to reduce toxic substances in the smoke gas to enter the human body and reduce the harm of smoking to the human body. In addition, since the graphene material has the above-mentioned excellent adsorption performance, only a small amount of graphene material are required to be used, moreover, the graphene is light, which helps to reduce the weight and size of the smoke gas filter device, making consumers feel comfortable during the use.

As a preferred embodiment of the present invention, the graphene material in the above-mentioned graphene material segment includes: graphene, aminated graphene, carboxylated graphene, sulfonated graphene, and thiolated graphene. The graphene material can fully adsorb the carcinogen in the smoke gas. Specifically, graphene has an extremely strong adsorption capacity for PAHs. Aminated graphene is a graphene modified with basic groups, which has strong adsorption capacity for acidic organics (such as formic acid, acetic acid, propionic acid, butyric acid, linolenic acid, linoleic acid, oleic acid, etc.). The carboxylated graphene is a graphene modified with a weakly acidic group, which has relatively strong adsorption capacity for alkaline substance (mainly includes a nitrogen compound such as ammonia, nicotine, nornicotine, neonicotine, anatabine, nitrosamine, etc.). Sulfonated graphene is a graphene modified with a strong acid group, which has extremely strong adsorption capacity for alkaline substances (mainly includes a nitrogen compound such as ammonia, nicotine, nornicotine, neonicotine, anatabine, nitrosamine, etc.). The content of alkaline substances in the smoke gas is high. Therefore, the carboxylated graphene is combined with sulfonated graphene to ensure high efficient filtration of harmful alkaline substances. Thiolated graphene has an extremely strong adsorption capacity for heavy metals (such as lead, mercury, nickel, cadmium, arsenic, polonium) and radioactive substances. Thus, the graphene material including the above-mentioned materials can have good adsorption capability for PAHs, acids, alkaline substances, and heavy metals in the smoke gas at the same time. More preferably, in the above-mentioned graphene material, the weight ratio of graphene, carboxylated graphene, sulfonated graphene, aminated graphene and thiolated graphene is 1:(0.2 to 0.4):(0.15 to 0.4):(0.1 to 0.2):(0.1 to 0.2), the weight ratio of carboxylated graphene to sulfonated graphene is preferably (1.5 to 2):1.

Besides, for graphene materials containing both graphene modified with acidic functional groups (such as carboxylated graphene, sulfonated graphene) and graphene modified with alkaline functional groups (aminated graphene), the above-mentioned two functionalized graphenes are preferably not in direct contact, so as to reduce the probability of spontaneous stacking in presence of water vapors. For example, the graphene material segment includes graphene layers modified with acidic functional groups, graphene layers modified with alkaline functional groups, and other graphene layers (the rest of the graphene materials in the above-mentioned graphene materials except for graphene layers modified with acidic functional groups and graphene layers modified with alkaline functional groups). Other graphene layers are arranged between graphene modified with acidic functional groups and graphene modified with alkaline functional groups.

Further, the above-mentioned graphene material may further include a hydroxylated graphene and/or an octadecylated graphene. Among them, hydroxylated graphene has a strong adsorption capacity for the substances with relative large polarity (such as methanol, butanol, pentanol, octanol, tetracosane, octacosanol, phytol, solanesol, cholesterol, stigmasterol, and β-sitosterol). Octadecylated graphene has a relatively strong adsorption capacity for alkanes, such as C25-C35 straight-chain alkanes transferred to the gas phase through the combustion of the tobacco wax. The weight ratio of the hydroxylated graphene to the graphene may be (0.05 to 0.1):1. The weight ratio of the octadecylated graphene to the graphene may be (0.05 to 0.1):1.

As for the amount of graphene material used, due to the high adsorption of the graphene material, the amount of the graphene material used relative to the existing filter material is extremely low. More than 0.5 mg of the amount of the graphene material used can ensure a better adsorption effect. Certainly, those skilled in the art could understand that the greater the amount of graphene material used, the greater will be the adsorption amount. However, due to the extremely strong adsorption performance of graphene materials, the larger amount of the graphene material may lead to a situation that the aroma components producing pleasant feelings on the human body and harmless to the human body in the smoke gas are also filtered (for example, olefins compounds such as neophytadiene; alcohol compounds such as solanesol, benzyl alcohol, and phenethyl alcohol; carboxylic compounds such as 3-methyl pentanoic acid and isovaleric acid; phenolic compounds such as eugenol and isoeugenol), which will reduce sensory enjoyment of the smokers. In view of this, the preferred embodiment of the present invention controls the amount of the graphene material used to be less than 50 mg, more preferably 1 mg to 35 mg.

In the smoke gas filter device provided by this embodiment, the smoke gas filter channel L is used to collect the smoke gas for centralized filtration. The shape of cross section of the above-mentioned smoke gas filter channel L may be a circle, a rectangle, a triangle, a hexagon, etc. The embodiment of the present invention uses a smoke gas filter channel with a circular cross section. The smoke gas filter channel L may be formed by a shell. Referring to FIG. 1, the smoke gas filter device includes a shell 2. The shell 2 forms the above-mentioned smoke gas filter channel L. In addition, the smoke gas filter device may further include: a first gas-permeable support segment 31 and a second gas-permeable support segment 32 arranged in the smoke gas filter channel L; the graphene material segment 1 is arranged between the first gas-permeable support segment 31 and the second gas-permeable supports segment 32.

The above-mentioned first gas-permeable support segment 31 and second gas-permeable support segment 32 are used to form a space defining the position of the graphene material, preventing the amorphous graphene material (such as powder, aerogel and film) from being carried out of the filter device together with the smoke gas. The materials of the first gas-permeable support segment 31 and the second gas-permeable support segment 32 may be any materials having air permeability and supporting performance, preferably the nontoxic materials. Specifically, the materials of the support segment may be cellulose acetate, polypropylene, alumina, or cotton. Correspondingly, the support segment may be a cellulose acetate segment, a polypropylene segment, an alumina segment, or a cotton segment. In addition, since the graphene material only has a small size in the dimension of the thickness and has a relatively large size in the dimensions of the length and the width, once the material gap on the end surface, whereon the support segment and the graphene material segment in contact is not smaller than 10 μm, the blocking effect for the graphene material may be achieved, preventing the graphene material from entering the support segment and affecting the adsorption effect.

The tobacco filter devices provided by the above-mentioned two embodiments have the advantages of high adsorption capacity, firm adsorption, and light weight. Besides, the filter devices can be reused, which is beneficial for energy conservation.

The above-mentioned shell 2 may be made of a hard material or a soft material. In the first case, when a hard material is used, the smoke gas filter device may be an external type, i.e. it is sleeved on the cigarette holder segment during smoking. Such a smoke gas filter device has the advantage that it can be used repeatedly. Referring to FIG. 2, which shows the structure of a smoke gas filter provided in the second embodiment of the present invention. The shell in the smoke gas filter device is a hard shell, the shell successively includes a cigarette accommodating segment S1 and a filter segment S2 along the axial direction of the shell. The filter segment S2 forms the above-mentioned smoke gas filter channel; the end of the cigarette accommodating segment S1 is formed with a cigarette accommodating chamber for accommodating the cigarette, and the cigarette accommodating chamber communicates with the smoke gas filter channel.

During the use, tobacco products such as cigarettes can be put into the cigarette accommodating chamber. When a person smokes, the smoke gas sucked out can be filtered by the filter segment S2 and then inhaled by the human body.

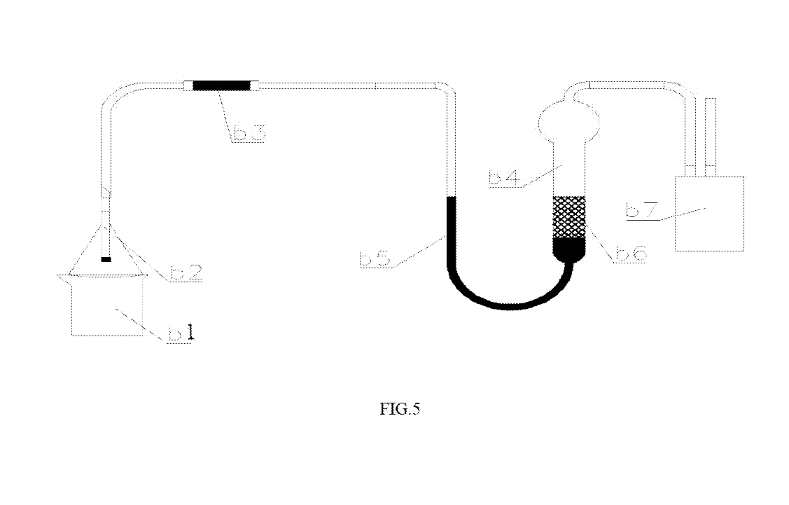

Further, in order to facilitate the smoker to hold the smoke gas filter device, the smoke gas filter device preferably further includes a cigarette holder segment S1. Referring to FIG. 3, the cigarette holder segment S1 communicates with the second end of the smoke gas filter channel of the filter segment S2, i.e. the shell successively includes a cigarette accommodating segment S1, a filter segment S2, and a cigarette holder segment S3 along the axial direction thereof. In addition, from the outer surface of one end of the cigarette holder segment S3 close to the filter segment S2 to the outer surface of the end of the cigarette holder segment S3 far from the filter segment S2, arc surfaces with gradually decreasing cross sections are formed, thereby improving the comfort feeling of the smoker.

In the smoke gas filter device provided by the above-mentioned two embodiments, preferably, the cigarette accommodating segment S1 is detachably connected to the filter segment S2, for example, screw connection, snap connection, etc. The advantage of this structure is as follows: on one hand, the adaptability of the smoke gas filter device to different types of tobacco products is improved by replacing the cigarette accommodating segment S1 with different inner diameters. For example, cigarette accommodating segment S1 of a plurality of models (inner diameter of a cigarette accommodating chamber) may be provided so as to be able to adapt to ordinary cigarettes, ladies' cigarettes, and different types of cigars, respectively. On the other hand, it is also convenient for the consumer to replace the filter material in the filter segment S2, thereby prolonging the service life of the tobacco filter device by replacing the filter material. Further, as described above, the amount of the graphene material used determines the filter effect, the drawbacks exist when the amount of graphene material used is either too large or too small. In order to facilitate the consumers to control the amount of the graphene material used for the replacement, the filter segment S2 of the above shell is preferably provided with an indication part. The indication part is used to indicate the volume of the graphene material placed. Because the volume of the material has a corresponding relationship with the weight, providing an indication part may conveniently prompt the operator with the amount of graphene material to be placed. The indication part may be an indication line, an indication groove, or an indication protrusion, etc.

In addition, the cigarette holder segment S3 may also be detachably connected to the filter segment S2, thereby when the cigarette holder segment S3 is damaged or is not sufficiently clean, the cigarette holder segment S3 may be replaced to prolong the service life of the smoke gas filter device.

In the second case, when the above-mentioned shell of the smoke gas filter device is made of a soft material, it can be integrally formed with the tobacco. Referring to FIG. 4, which shows a structure of a tobacco product provided by a third embodiment of the present invention. The tobacco product includes a tobacco segment 4 and a smoke gas filter device provided by the above-mentioned first embodiment. The smoke gas filter device is connected to one end of the tobacco segment 4. Since the tobacco and the smoke gas filter device are formed into an integrated structure, the consumer does not need to additionally install the filter device before smoking, which is convenient to use. The above-mentioned tobacco product may be a cigarette, a cigar, a cigarillo, etc.

In this embodiment, the smoke gas filter device includes a first gas-permeable support segment 31, a graphene material segment 1, a second gas-permeable support segment 32, and a shell 2. The graphene material segment 1 is arranged between the first gas-permeable support segment 31 and the second gas-permeable support segment 32. The first gas-permeable support segment 31 is connected to the tobacco segment 4.

In such a tobacco product, material of the shell 2 of the smoke gas filter device is preferably a gas-permeable material, and specifically may be a cellulosic material, such as tipping paper, cigarette paper, cellulose fiber paper, etc. The tobacco segment may specifically include a tobacco core 41, and a cigarette paper 42 wrapped on the periphery of the tobacco core 41. The above-mentioned tobacco core may be one or more of tobacco shreds, powdery tobacco, reconstituted tobacco, tobacco stems, tobacco fibers, tobacco flakes, or cut tobacco.

The tobacco product provided by the third embodiment of the present invention has the advantages of high adsorption capacity, firm adsorption, and light weight, and is formed into an integrated structure with tobacco, which is convenient for consumers to use.

The solutions of the present invention are further described below in conjunction with specific embodiments.

[PAHs Adsorption Test]

Detection device: Structure is shown in FIG. 5, which consists of the following seven parts: receiving beaker b1, test cigarette b2 (commercial type A cigarette), smoke gas filter device b3; U-shaped absorption tube b4; absorption solvent b5; alumina sieve plate b6, air sampler b7; each part has functions as follows:

Receiving beaker b1 is used to receive the embers formed in the combustion of test cigarettes during the test;

Test cigarette b2 is used to simulate the tobacco burning in the real process.

Smoke gas filter device b3 is used to filter the smoke gas.

U-shaped absorption tube b4 is used to support the absorption solvent b5 and prevent the solvent from falling into the air sampler.

Absorption solvent b5 is used to dissolve the gas produced after burning tobacco. The absorption solvent b5 in this test is n-hexane.

Alumina sieve plate b6 is used to prevent backward suction. The hole of the porous sieve plate is used as the boiling core. During vacuum pumping, the solvent can be boiled without directly inhaled into the atmospheric sampler.

The air sampler b7 i.e. the atmospheric sampler, which is used to perform vacuum pumping operation and provide negative pressure. In the tests under certain conditions, the air sampler is also used to store atmospheric samples.

Detection method is as follows: 1. setting the smoke gas filter device b3 to be empty, the smoke gas generated by the test cigarette b2 is directly absorbed by the absorption solvent b5, and the experiment continues for 5 min and then the test is stopped, taking out the absorption solvent b5, testing the content of the compound to be measured in the absorbed solvent through GC-MS, HPLC, ICP-MS, AAS or other test methods, the measured content is used as a reference quantity t0;

2. setting different smoke gas filter devices b3, the smoke gas produced by the test cigarette b2 is directly absorbed by the absorption solvent b5 after passing through the smoke gas filter device b3, the experiment continues for 5 min and then the test is stopped; taking out the absorption solvent b5, testing the content of the compound to be measured in the absorbed solvent through the GC-MS. HPLC, ICP-MS, AAS or other test methods, the measured content is used as the comparison quantity t1;

3. calculating the compound removal rate: compound removal rate (%)=comparison quantity t1/reference quantity t0.

Test Sample:

### Comparative Example D

The smoke gas filter device is a commercially available filter cigarette holder, material used in the filter cigarette holder is cellulose acetate, diameter of it is 1 cm, length of it is 2 cm.

### Test Example

The smoke gas filter devices Nos. 1 to 20 are provided. The structures of the smoke gas filter devices are all as shown in FIG. 1. The first gas-permeable support segment and the second gas-permeable support segment both have the diameter of 1 cm and the length of 5 mm. The rest of the structure information is listed in Table 1.

TABLE 1
Structures of Smoke Gas Filter Device of Test Example
for PAHs Adsorption Test

| | Gas-permeable Support | | |
|---|---|---|---|
| No. | Segment | Graphene Material Segment | |
| 1 | material: cellulose acetate | material: graphene powder | weight: 10 mg |
| 2 | material: cellulose acetate | material: aminated graphene | weight: 10 mg |
| | | powder | |
| 3 | material: cellulose acetate | material: carboxylated graphene | weight: 10 mg |
| | | powder | |
| 4 | material: cellulose acetate | material: sulfonated graphene | weight: 10 mg |
| | | powder | |
| 5 | material: cellulose acetate | material: thiolated graphene | weight: 10 mg |
| | | powder | |
| 6 | material: polypropylene | material: cyanographene aerogel | weight: 10 mg |
| 7 | material: alumina | material: nitrographene powder | weight: 10 mg |
| 8 | material: cotton | material: borate graphene | weight: 10 mg |
| | | powder | |
| 9 | material: cellulose acetate | material: phosphate graphene | weight: 10 mg |
| | | powder | |
| 10 | material: cellulose acetate | material: hydroxylated graphene | weight: 10 mg |
| | | powder | |
| 11 | material: cellulose acetate | material: thiolated graphene | weight: 10 mg |
| | | powder | |
| 12 | material: cellulose acetate | material: methylated graphene | weight: 10 mg |
| | | powder | |
| 13 | material: cellulose acetate | material: allylated graphene | weight: 10 mg |
| | | powder | |
| 14 | material: cellulose acetate | material: trifluoromethylated | weight: 10 mg |
| | | graphene powder | |
| 15 | material: cellulose acetate | material: dodecylated graphene | weight: 10 mg |
| | | powder | |
| 16 | material: cellulose acetate | material: octadecylated graphene | weight: 10 mg |
| | | powder | |
| 17 | material: cellulose acetate | material: fluorinated graphene | weight: 10 mg |
| | | film powder | |
| 18 | material: cellulose acetate | material: brominated graphene | weight: 10 mg |
| | | powder | |
| 19 | material: cellulose acetate | material: chlorinated graphene | weight: 0.5 mg |
| | | powder | |
| 20 | material: cellulose acetate | material: iodinated graphene | weight: 50 mg |
| | | powder | |

Test results: listed in Table 2

TABLE 2
Results of PAHs Adsorption Test (Removal Rate)

| Test Item | D | 1 | 2 | 3 | 4 | 5 | 6 | 7 | 8 | 9 |
|---|---|---|---|---|---|---|---|---|---|---|
| naphthalenes | 31.7% | 86.9% | 80.3% | 79.6% | 81.9% | 75.3% | 72.8% | 78.6% | 75.5% | 76.7% |
| acenaphthene | 50.8% | 88% | 81.2% | 80.5% | 83.7% | 80% | 76.8% | 80.1% | 79% | 81% |
| acenaphthylene | 31.4% | 95% | 92% | 91% | 92.5% | 90.1% | 88.3% | 91.05% | 89.7% | 91.3% |
| fluorene | 55.7% | 99.7% | 97.4% | 95.8% | 99.2% | 92.6% | 90.7% | 94.8% | 91.6% | 93.2% |
| phenanthrene | 49.1% | 99.1% | 96.8% | 96.3% | 98.4% | 93.9% | 90.1% | 95.8% | 94.5% | 93.1% |
| fluoranthene | 45.2% | 99.8% | 95.7% | 96% | 98.1% | 95.5% | 95.2% | 95.3% | 95.4% | 95.6% |
| benzo[a]pyrene | 81.1% | 100% | 98.6% | 96.1% | 100% | 94.1% | 95.5% | 95.7% | 95.3% | 95.9% |
| benzo[e]pyrene | 85.2% | 100% | 100% | 98.9% | 98.4% | 97.5% | 95.1% | 97.5% | 96.5% | 98.1% |
| catechol | 34.2% | 78% | 77.3% | 75% | 77.3% | 74.8% | 72.9% | 74.5% | 73.7% | 73.2% |
| resorcinol | 33.7% | 88% | 85.4% | 82.8% | 85.2% | 82.1% | 81.1% | 81.7% | 81.2% | 81.8% |
| benzo[b]fluoranthene | 82.3% | 100% | 100% | 98.5% | 99.7% | 97.9% | 97.5% | 97.3% | 96.5% | 98.1% |
| benzo[k]fluoranthene | 81.2% | 100% | 97.5% | 95.2% | 98.8% | 94.6% | 92.8% | 95.1% | 93.8% | 93.9% |
| benzo[j]fluoranthrene | 80.2% | 100% | 100% | 100% | 99.7% | 99.8% | 99.9% | 99% | 97.9% | 99.7% |
| dibenzo[a,h]anthracene | 84.4% | 100% | 99.6% | 100% | 99.7% | 97.6% | 95.3% | 98.7% | 98.7% | 96.6% |
| dibenzo[a,h]acridine | 61.1% | 100% | 97.3% | 97.5% | 100% | 100% | 99.6% | 96.5% | 100% | 100% |
| dibenzo[a,j]acridine | 57.1% | 100% | 99.9% | 99.5% | 99.8% | 98.3% | 95.2% | 98.9% | 97.3% | 98.5% |
| 7-H-dibenzo[c,g]carbazole | 68.1% | 98.9% | 96.8% | 95.4% | 97.5% | 94.3% | 90.6% | 96.0% | 95.8% | 94.8% |
| indeno pyrene, | 55.2% | 100% | 99.1% | 99.2% | 99.4% | 99.2% | 99.5% | 98.6% | 98.8% | 98.8% |
| methyleugenol | 58.8% | 85% | 80.2% | 81.6% | 83.6% | 82.6% | 81.9% | 80.8% | 81.9% | 82.8% |
| phenol | 36.6% | 79% | 78.4% | 78% | 79% | 78% | 77.5% | 77.8% | 77.6% | 78.4% |

| Test Item | 10 | 11 | 12 | 13 | 14 | 15 | 16 | 17 | 18 | 19 | 20 |
|---|---|---|---|---|---|---|---|---|---|---|---|
| naphthalenes | 85.6% | 83.3% | 81.6% | 80.9% | 71.4% | 73.5% | 74.1% | 70.9% | 82.6% | 70.4% | 99.5% |
| acenaphthene | 83.1% | 82.6% | 81.9% | 82.8% | 75.6% | 77% | 75.7% | 73.8% | 83.9% | 72.3% | 97.5% |
| acenaphthylene | 90.3% | 91.6% | 93.5% | 90.6% | 85.9% | 88.5% | 86.3% | 85.2% | 92.7% | 72.5% | 95% |
| fluorene | 95.7% | 94.8% | 97% | 99% | 90.1% | 92.4% | 90.2% | 89.1% | 99.5% | 75.1% | 100% |
| phenanthrene | 92.1% | 98.3% | 97.2% | 97.5% | 87.4% | 91.3% | 92.6% | 90.2% | 98.7% | 72.8% | 100% |
| fluoranthene | 95.6% | 99.5% | 96.1% | 97.9% | 95.2% | 95.7% | 95.5% | 95.4% | 98.3% | 95% | 100% |
| benzo[a]pyrene | 98.6% | 100% | 98.5% | 99.4% | 995.5% | 95.9% | 95.5% | 95.2% | 100% | 95% | 100% |
| benzo[e]pyrene | 99.7% | 98.9% | 99.6% | 96.3% | 995.5% | 96.8% | 96.1% | 995.5% | 98.5% | 95.1% | 100% |
| catechol | 75.9% | 73.6% | 77.5% | 76.2% | 71.3% | 74.2% | 70.5% | 71.5% | 78.1% | 68.9% | 97.4% |
| resorcinol | 88.2% | 86.7% | 86.1% | 83.9% | 80% | 83.1% | 80.5% | 80.3% | 85.7% | 75.3% | 98.3% |
| benzo[b]fluoranthene | 93.5% | 98.6% | 100% | 98.9% | 96.3% | 97.2% | 94.3% | 95.1% | 99.7% | 85.6% | 100% |
| benzo[k]fluoranthene | 97.8% | 98.5% | 97.8% | 96.5% | 91.9% | 93.5% | 91.8% | 90.6% | 98.5% | 82.2% | 100% |
| benzo[j]fluoranthrene | 98.6% | 99.3% | 99.9% | 98.9% | 99.9% | 100% | 95.4% | 94.5% | 99.2% | 2.8% | 100% |
| dibenzo[a,h]anthracene | 99.6% | 98.7% | 99.7% | 99.3% | 98.5% | 98% | 96.8% | 95% | 99.8% | 85.4% | 100% |
| dibenzo[a,h]acridine | 98.7% | 98.5% | 98% | 99.6% | 100% | 99.2% | 99.7% | 98.8% | 99.9% | 83.7% | 100% |
| dibenzo[a,j]acridine | 99.6% | 99.3% | 99.5% | 99.3% | 96.7% | 94.6% | 98.3% | 95.2% | 99.5% | 75.9% | 100% |
| 7-H-dibenzo[c,g]carbazole | 98.5% | 98.5% | 97.2% | 96.8% | 90.3% | 93.1% | 93.1% | 90.6% | 97.2% | 72.7% | 100% |
| indeno pyrene, | 98.6% | 99.1% | 99% | 99.4% | 99.6% | 99.6% | 98.2% | 99.5% | 99% | 85.2% | 100% |
| methyleugenol | 84% | 83.1% | 81.5% | 82.1% | 80.5% | 82.9% | 80.5% | 81.9% | 84.1% | 70.9% | 98.9% |
| Phenol | 75.6% | 72.8% | 78.9% | 78.6% | 77.7% | 78% | 75.1% | 77.5% | 80% | 66.2% | 95.1% |

Referring to Table 2, compared with the prior art, the smoke gas filter device provided by the present invention has better filter effect on PAHs, and even if a person smokes for a long time, the adsorption capacity to PAHs is still high.

[Comprehensive Adsorption Test]

Detection Device:

Detection device is the same as that in PAHs adsorption test.

Detection Method:

The organic phase absorption solvent b5 is isopropanol, and the rest of the solvents and the detection steps are the same as the corresponding solvents and steps in PAHs adsorption test; absorption solvent b5 for the heavy metal part is 5% nitric acid, which is detected by the methods such as AAS or ICP-MS, and the rest of the solvents and detection steps are the same as the corresponding solvents and steps in the adsorption PAHs test.

Test Sample:

### Comparative Example: Sample 1 in PAHs Test

### Test Example

The smoke gas filter devices Nos. 21 to 25 are provided. The structures of the smoke gas filter devices are as shown in FIG. 1. The first gas-permeable support segment and the second gas-permeable support segment are the same as the test example in the PAHs test: the rest of the structure information is listed in the following table.

TABLE 3
Structures of Smoke Gas Filter Device in Test
Example for Comprehensive Adsorption Test

| | Gas-permeable Support | | |
|---|---|---|---|
| No. | Segment | Graphene Material Segment | |
| 21 | material: cellulose | material: graphene, carboxylated | weight: 10 mg |
| | acetate | graphene, sulfonated graphene, | ratio: 1:1:1:1:1 |
| | | aminated graphene and thiolated | |
| | | graphene | |
| 22 | material: cellulose | material: graphene, carboxylated | weight: 10 mg |
| | acetate | graphene, sulfonated graphene, | ratio: 1:0.2:0.15:0.1:0.1 |
| | | aminated graphene and thiolated | |
| | | graphene | |
| 23 | material: cellulose | material: graphene, carboxylated | weight: 10 mg |
| | acetate | graphene, sulfonated graphene, | ratio: 1:0.4:0.4:0.2:0.2 |
| | | aminated graphene and thiolated | |
| | | graphene | |
| 24 | material: cellulose | material: graphene, carboxylated | weight: 10 mg |
| | acetate | graphene, sulfonated graphene, | ratio: 1:0.3:0.2:0.1:0.2 |
| | | aminated graphene and thiolated | |
| | | graphene | |
| 25 | material: cellulose | material: graphene, carboxylated | weight: 10 mg |
| | acetate | graphene, sulfonated graphene, | ratio: |
| | | aminated graphene, thiolated graphene, | 1:0.2:0.1:0.2:0.1:0.1:0.1 |
| | | hydroxylated graphene and | |
| | | octadecylated graphene | |

Test results: listed in Table 4

TABLE 4
Results of Comprehensive Adsorption Test (Removal Rate)

| Test Item | 1 | 21 | 22 | 23 | 24 | 25 |
|---|---|---|---|---|---|---|
| formic acid | 40.6% | 85% | 87.1% | 89.4% | 95.7% | 96.2% |
| oleic acid | 78.6% | 87.5% | 95.4% | 96.2% | 95% | 97.4% |
| nicotine | 27% | 80.3% | 86% | 86.1% | 90.3% | 87.6% |
| aniline | 85.3% | 85.9% | 90.9% | 92.4% | 97.2% | 96.9% |
| nitrosamine | 82.6% | 85% | 90.6% | 91.3% | 96.9% | 95.7% |
| lead | 18.6% | 84.7% | 87.7% | 89.3% | 90.6% | 86.9% |
| mercury | 17.3% | 85.1% | 88.1% | 90.7% | 92.5% | 87.4% |
| polonium | 13.7% | 84.1% | 87.2% | 90% | 90.3% | 85.9% |
| C1-C24 alkanol | 58.9% | 59.3% | 60% | 58.5% | 60.2% | 94.6% |
| C28 alkanol | 67.3% | 67.2% | 67.5% | 67.3% | 68.2% | 90.2% |
| C25-C35 | 43.9% | 44% | 44% | 43.3% | 44.6% | 93.9% |
| alkanol | | | | | | |

Table 4 shows that the use of graphene, aminated graphene, carboxylated graphene, sulfonated graphene, and thiolated graphene for graphene materials, helps to further improve the adsorption ability of the smoke gas filter device to acidic organic substances, alkaline substances, and heavy metals, achieving the comprehensive adsorption to toxic substances. The further addition of hydroxylated graphene and octadecylated graphene also helps to improve the adsorption ability to substances with great polarity and straight-chain alkanes.

[PAHs and Aroma Adsorption Test]

Detection Devices:

Detection device is the same as the detection device in the PAHs adsorption test.

Detection Method:

The absorption solvent b5 is methanol-acetonitrile, and the rest of the solvents and detection steps are the same as the corresponding steps in the PAHs adsorption test. Wherein, the PAHs removal index is the average value of indexes in Table 2.

Test Sample:

### Comparative Example: Sample 1 in the PAHs Test

The smoke gas filter devices Nos. 26 to 31 are provided. The differences between the smoke gas filter devices of Samples 26 to 31 and the Sample 1 in the PAHs test merely is the different weight of the graphene powders in the graphene material segment. The weights of the graphene powders from Samples 26 to 31 are as follows: 0.2 mg, 0.5 mg, 1 mg, 35 mg, 50 mg, 60 mg.

Test results: listed in Table 5

TABLE 5
Results of PAHs and Aroma Adsorption Test (Removal Rate)

| Test Item | 1 | 26 | 27 | 28 | 29 | 30 | 31 |
|---|---|---|---|---|---|---|---|
| neophytadiene | 45.1% | 41.5% | 41.9% | 42.6% | 50.2% | 69.7% | 88.9% |
| solanesol | 46.3% | 42.2% | 42.5% | 46.1% | 50.6% | 70.3% | 89% |
| benzyl alcohol | 45.2% | 41.4% | 41.6% | 45% | 50.3% | 69.8% | 88.6% |
| 3-methylpentanoic acid | 45.1% | 41.1% | 41.4% | 44.9% | 50.2% | 69.5% | 88.3% |
| isovaleric acid | 45.2% | 41.2% | 41.5% | 45% | 50.4% | 69.6% | 88.5% |
| eugenol | 45% | 40.3% | 41.2% | 44.8% | 50.3% | 69.6% | 88.5% |
| isoeugenol | 45.4% | 41.5% | 41.7% | 45.2% | 50.5% | 70% | 89.1% |
| PAHs | 94.8% | 85.2% | 92.4% | 93.9% | 96.1% | 97.3% | 99.1% |

Table 5 shows that the content of graphene material has an effect on PAHs and aroma components. When the amount of graphene material used is 0.5 mg to 50 mg, both the high removal rate of PAHs and the retention of aroma components can be achieved; when the amount of graphene material used is 1 mg to 35 mg, the effect is better.

The above descriptions are merely preferred embodiments of the present invention and are not intended to limit the present invention. Any modifications, equivalent substitutions, and improvements made within the spirit and principle of the present invention shall be included in the protection scope of present invention.

What is claimed is:

1. A smoke gas filter device, wherein
the smoke gas filter device is formed with a smoke gas filter channel, and a graphene material segment is arranged in the smoke gas filter channel, the graphene material segment is a graphene material powder segment, a graphene material aerogel segment or a graphene material film segment;
the graphene material is graphene and/or functionalized graphene; the functionalized graphene is one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylate graphene, dodecylated graphene, octadecylated graphene, fluorinated graphene, brominated graphene, chlorinated graphene, and iodinated graphene.

2. The smoke gas filter device of claim 1, wherein
the graphene material segment comprises: the graphene, the aminated graphene, the carboxylated graphene, the sulfonated graphene, and the thiolated graphene.

3. The smoke gas filter device of claim 1, wherein
the smoke gas filter device comprises a shell, the shell forms the smoke gas filter channel; the smoke gas filter device further comprises: a first gas-permeable support segment arranged in the smoke gas filter channel and a second gas-permeable support segment arranged in the smoke gas filter channel; the graphene material segment is arranged between the first gas-permeable support segment and the second gas-permeable support segment.

4. The smoke gas filter device of claim 3, wherein
the first gas-permeable support segment and/or the second gas-permeable support segment is a cellulose acetate segment, a polypropylene segment, an alumina segment, or a cotton segment.

5. The smoke gas filter device of claim 3, wherein
the shell is a hard shell, the shell successively comprises a filter segment and a cigarette accommodating segment along an axial direction of the shell; the filter segment forms the smoke gas filter channel; the cigarette accommodating segment communicates with a first end of the smoke gas filter channel; the cigarette accommodating segment is formed with a cigarette accommodating chamber for accommodating a cigarette.

6. The smoke gas filter device of claim 5, further comprising
a cigarette holder segment, the cigarette holder segment communicates with a second end of the smoke gas filter channel of the filter segment; in the cigarette holder segment, from an outer surface of a first end close to the filter segment to an outer surface of a second end far from the filter segment, arc surfaces with gradually decreasing cross sections are formed.

7. The smoke gas filter device of claim 6, wherein
the cigarette accommodating segment is detachably connected to the filter segment, and/or the cigarette holder segment is detachably connected to the filter segment.

8. The smoke gas filter device of claim 1, wherein
a weight of the graphene material segment is 0.5 mg to 50 mg.

9. A tobacco product, wherein the tobacco product comprises a tobacco segment, and the smoke gas filter device of claim 1, the smoke gas filter device is connected to an end of the tobacco segment.

10. An application of a graphene material in adsorbing polycyclic aromatic hydrocarbons, wherein
the graphene material is graphene and/or functionalized graphene; the functionalized graphene is one or more of aminated graphene, carboxylated graphene, sulfonated graphene, thiolated graphene, cyanographene, nitrographene, borate graphene, phosphate graphene, hydroxylated graphene, methylated graphene, allylated graphene, trifluoromethylate graphene, dodecylated graphene, octadecylated graphene, fluorinated graphene, brominated graphene, chlorinated graphene, and iodinated graphene.

11. The smoke gas filter device of claim 2, wherein
a weight of the graphene material segment is 0.5 mg to 50 mg.

12. The smoke gas filter device of claim 3, wherein
a weight of the graphene material segment is 0.5 mg to 50 mg.

13. The smoke gas filter device of claim 4, wherein
a weight of the graphene material segment is 0.5 mg to 50 mg.

14. The smoke gas filter device of claim 5, wherein
a weight of the graphene material segment is 0.5 mg to 50 mg.

15. The smoke gas filter device of claim 6, wherein
a weight of the graphene material segment is 0.5 mg to 50 mg.

16. The smoke gas filter device of claim 7, wherein
a weight of the graphene material segment is 0.5 mg to 50 mg.

17. A tobacco product, wherein the tobacco product comprises a tobacco segment, and the smoke gas filter device of claim 2, the smoke gas filter device is connected to an end of the tobacco segment.

18. A tobacco product, wherein the tobacco product comprises a tobacco segment, and the smoke gas filter device of claim 3, the smoke gas filter device is connected to an end of the tobacco segment.

19. A tobacco product, wherein the tobacco product comprises a tobacco segment, and the smoke gas filter device of claim 4, the smoke gas filter device is connected to an end of the tobacco segment.

20. A tobacco product, wherein the tobacco product comprises a tobacco segment, and the smoke gas filter device of claim 5 the smoke gas filter device is connected to an end of the tobacco segment.
